(19) United States
(12) Patent Application Publication
(10) Pub. No.: US 2014/0283666 A1
(43) Pub. Date: Sep. 25, 2014

(54) Circular Saw Blade

(71) Applicants: Liansheng Zhu, Hangzhou (CN); Xianhong Yu, Hangzhou (CN)

(72) Inventors: Liansheng Zhu, Hangzhou (CN); Xianhong Yu, Hangzhou (CN)

(73) Assignees: Bosch Power Toolls (China ) Co., Ltd., Hangzhou, Zhejiang (CN); Robert Bosch GmbH, Stuttgart (DE)

(21) Appl. No.: 14/241,927

(22) PCT Filed: Aug. 29, 2012
(86) PCT No.: PCT/CN2012/080715

§ 371 Date: Jun. 4, 2014

(30) Foreign Application Priority Data
Sep. 2, 2011 (CN) 201110269280.2

(51) Int. Cl. B23D 61/02

(52) U.S. Cl. CPC B23D 61/028
USPC 83/835

(57) ABSTRACT

A circular saw blade, includes a base plate and tips. A coating selected from the group consisting of molybdenum disulfide, tungsten disulfide, Teflon, and any combination thereof is applied on the tips.

### FIELD OF THE INVENTION

The invention relates to a circular saw blade, more particularly to a circular saw blade with coating on the tips.

### BACKGROUND OF THE INVENTION

As a cutting tool, a circular saw blade has been widely used in the processing of woods, aluminum profiles, steels, and the like. The tips of the circular saw blade are typically made of hard metals, which, however, have relatively low hardness and low wear resistance, resulting in a limited life time of the circular saw blade. In the prior art, different coatings are conventionally applied on the base sheet or tips of a circular saw blade, to gain different properties.

U.S. 2010/0122620A1 discloses a circular saw blade for lumber mill, comprising a ceramic coating deposited on cutting teeth as a thermal barrier, in order to inhibit abrupt increases in temperature of the cutting teeth during cutting operation.

DE19502162 discloses a circular saw blade with cutting teeth of steel, wherein a vibration-damping coating of plastics is applied on the areas of the teeth, in order to suppress the high-frequency vibration between the pipe and circular saw blade, and thereby to increase the service life of the circular saw blade.

CN2014529Y discloses a black diamond saw blade, comprising a diamond coating applied on its hard metal teeth, to increase the cutting life of the saw blade.

To satisify different application requirements, there still remains a need to provide a circular saw blade having low coefficient of friction, high wear resistance, and long cutting life, especially a circular saw blade used for cutting aluminum profiles, which has low coefficient of friction, high wear resistance, and long cutting life.

### SUMMARY OF THE INVENTION

According to one aspect of the invention, there is provided a circular saw blade, especially used for cutting aluminum profiles, comprising a base plate and tips, wherein a coating selected from the group consisting of molybdenum disulfide, tungsten disulfide, Teflon (polytetrafluoroethylene), and any combination thereof is applied on the tips.

In the circular saw blade according to the invention, the coating comprises a molybdenum disulfide coating, and has a thickness of from 15 μm to 35 μm.

In the circular saw blade according to the invention, the coating comprises a tungsten disulfide coating, and has a thickness of from 20 μm to 35 μm.

In the circular saw blade according to the invention, the coating comprises a Teflon coating, and has a thickness of from 15 μm to 35 μm.

In the circular saw blade according to the invention, the coating is applied on the tips by using a rotary spray process.

### BRIEF DESCRIPTION OF THE DRAWINGS

FIG. 1 shows schematically a circular saw blade according to an embodiment of the invention.

### DETAILED DESCRIPTION OF THE INVENTION

Unless otherwise stated, all patents, patent applications, articles and any other publications cited herein are hereby incorporated by reference in their entireties.

Unless defined otherwise, all technical and scientific terms used herein have the same meanings as commonly understood by one of ordinary skill in the art. In the case of conflict, the definitions given in the present description will control.

It is also noted that a list of upper preferable values and lower preferable values of an amount, concentration or other value or paramenter specifically discloses all ranges formed from any pair of an upper preferred value and a lower preferred value, regardless of whether additional ranges are separately disclosed. Unless otherwise stated, the value ranges listed herein are intended to include end points, and all integers and fractions within the ranges.

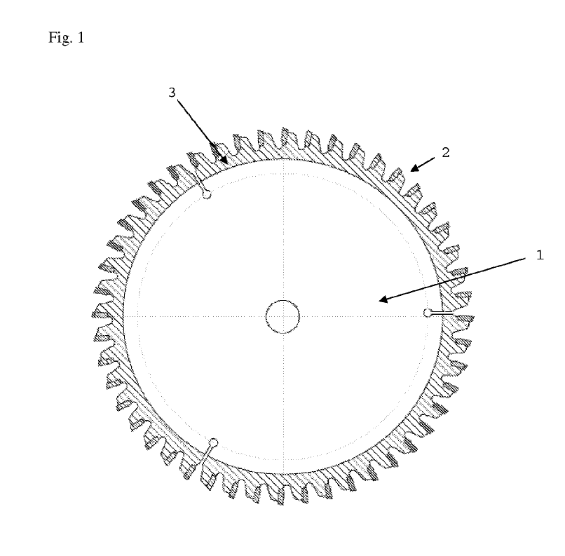

FIG. 1 depicts a circular saw blade according to an embodiment of the invention. The blade comprises a base plate (1) and tips (2), with a coating (3) applied on the tips. The base plate (1) may be made of materials commonly used in the art, for example, carbon tool steel, and the tips (2) may be made of materials commonly used in the art, for example, hard metals. The base plate (1) and the tips (2) may be made of the same or different materials.

The coating (3) is applied to improve the wear resistance of the tips. The coating comprises molybdenum disulfide, tungsten disulfide, Teflon (polytetrafluoroethylene), or any combination thereof, prefereably molybdenum disulfide.

The coating may be formed by applying a spraying solution on the tips by using a rotary spray process which is known in the art. The spraying solution may be prepared by dissolving a dry film lubricant based on molybdenum disulfide, tungsten disulfide, or Teflon in a suitable solvent. The dry film lubricant based on molybdenum disulfide, tungsten disulfide, or Teflon is known in the art and commercially available. The dry film lubricant is typically obtained by dispersing molybdenum disulfide, tungsten disulfide, or Teflon based solid lubricant in a suitable organic resin or inorganic binder, and subjecting to high temperature treatment.

In one embodiment of the invention, a molybdenum disulfide coating having a thickness of preferably from 15 to 35 μm is applied on the tips of the circular saw blade. In this embodiment, the coating has a coefficient of friction of from 0.03 to 0.08. The hardness of the coating, measured according to the Chinese standard GB/T6739-2006, is 7 H. The load capacity of the coating is larger than 65000 N/cm². The coating can withstand a wide work temperature ranging from −70° C. to 380° C.

In another embodiment of the invention, a tungsten disulfide coating having a thickness of preferably from 20 to 35μm is applied on the tips of the circular saw blade. In this embodiment, the coating has a coefficient of friction of from 0.03 to 0.08. The hardness of the coating, measured according to the Chinese standard GB/T6739-2006, is 9 H. The load capacity of the coating is larger than 80000 N/cm². The coating can withstand a wide work temperature ranging from −70° C. to 380° C.

In yet another embodiment of the invention, a Teflon coating having a thickness of preferably from 15 to 35 μm is applied on the tips of the circular saw blade. In this embodiment, the coating has a coefficient of friction of from 0.007 to 0.012. The hardness of the coating, measured according to the Chinese standard GB/T6739-2006, is 4 H. The load capacity of the coating is larger than 45000 N/cm². The coating can withstand a wide work temperature ranging from 0° C. to 400° C.

The circular saw blade according to the invention is preferably used for cutting aluminum profiles. During cutting operation, the coating is capable of reducing the coefficient of friction, improving the wear resistance and prolonging the cutting life of the circular saw blade.

The following examples are given to illustrate the circular saw blade according to the invention, but are not to be construed as limiting the scope of the invention in any way.

The properties of the circular saw blade are measured as follows:

Coefficient of friction: measured according to a standard ASTM D2714

Hardness: measured according to the Chinese standard GB/T6739-2006 using a pencil hardness tester

Load capacity, in N/cm²: measured according to a standard ASTM-D2625

Cutting life: measured according to a standard ASTM D-2714.

### EXAMPLE 1

A spraying solution was prepared by mixing a molybdenum disulfide based dry film lubricant and dimethyl formamide at a weight ratio of 1:0.1, and then applied on the tips of a circular saw blade by using a rotary spray process. A molybdenum disulfide coating having a thickness of 20 μm was obtained. The properties of the coating were measured and the results were summarized in table 1.

### EXAMPLE 2

A spraying solution was prepared by mixing a tungsten disulfide based dry film lubricant and dimethyl formamide at a weight ratio of 1:0.1, and then applied on the tips of a circular saw blade by using a rotary spray process. A tungsten disulfide coating having a thickness of 25 μm was obtained. The properties of the coating were measured and the results were summarized in table 1.

EXAMPLE 3

A spraying solution was prepared by mixing a Teflon based dry film lubricant and pure water at a weight ratio of 1:0.4, and then applied on the tips of a circular saw blade by using a rotary spray process. A Teflon coating having a thickness of 35 μm was obtained. The properties of the coating were measured and the results were summarized in table 1.

TABLE 1
the property parameters of various coatings

| Parameter | MoS₂ coating | WS₂ coating | Teflon coating |
|---|---|---|---|
| Coating thickness (μm) | 20 | 25 | 35 |
| Coefficient of friction | 0.05 | 0.03 | 0.008 |
| (smoothing property) | | | |
| Hardness | 7H | 9H | 4H |
| Work temperature | −70° C.~ | −70° C.~ | 0° C.~ |
| (high temperature | 380° C. | 380° C. | 400° C. |
| resistance) | | | |
| Antisticking property | 114° | 129° | 85° |
| (¢2 mm water drop test) | | | |
| Load capacity (N/cm²) | >65000 | >80000 | >45000 |
| Oil resistance | Excellent | Excellent | Excellent |
| Corrosion resistance | >100H | >300H | >500H |
| (salt spray test) | | | |
| Cutting life | 250 000 | 400 000 | 120 000 |
| | times | times | times |

### EXAMPLE 4

A comparison test was conducted between the respective circular saw blades as shown in table 2 below with the molybdenum disulfide coating obtained according to Example 1 and without coating.

Test material: 40*40*2 mm aluminum profile

Test equipment: aluminum profile cutting machine

TABLE 2
comparison test between a circular saw blade with the
molybdenum disulfide coating and without coating

| Blade | Average, cut | Average cut | With coating/ |
|---|---|---|---|
| specification | with coating | without coating | without coating |
| Ø254 × 96T | 297 | 91 | 3.3 |
| Ø216 × 100T | 897 | 271 | 3.3 |
| Ø254 × 120T | >600 | 300 | 2 |

As can be seen from the results in table 2, the circular saw blades with the molybdenum disulfide coating according to the invention have a cutting life more than two times longer than the circular saw blades without coating.

### EXAMPLE 5

A comparison test was conducted between the respective circular saw blades as shown in table 3 below with the tungsten disulfide coating obtained according to Example 2 and without coating.

Likewise, a comparison test was conducted between the respective circular saw blades as shown in table 4 below with the Teflon coating obtained according to Example 3 and without coating.

Test material: 40*40*2 mm aluminum profile

Test equipment: aluminum profile cutting machine

TABLE 3
comparison test between a circular saw blade with
the tungsten disulfide coating and without coating

| Blade | Average cut | Average cut | With coating/ |
|---|---|---|---|
| specification | with coating | without coating | without coating |
| Ø254 × 120T | 105 | 51 | 2.1 |
| Ø254 × 96T | 273 | 91 | 3.0 |

TABLE 4
comparison test between a circular saw blade
with the Teflon coating and without coating

| Blade | Average cut | Average cut | With coating/ |
|---|---|---|---|
| specification | with coating | without coating | without coating |
| Ø254 × 120T | 89 | 51 | 1.7 |
| Ø254 × 96T | 273 | 91 | 3.0 |

As can be seen from the results in tables 3 and 4, the circular saw blades with the tungsten disulfide coating or the Teflon coating according to the invention have a cutting life about 2 to 3 times longer than the circular saw blades without coating.

1. A circular saw blade, comprising a base plate and tips, wherein a coating selected from the group consisting of molybdenum disulfide, tungsten disulfide, Teflon, and any combination thereof is applied on the tips.

2. The circular saw blade according to claim 1, wherein the coating comprises a molybdenum disulfide coating, and has a thickness of from 15 μm to 35 μm.

3. The circular saw blade according to claim 1, wherein the coating comprises a tungsten disulfide coating, and has a thickness of from 20 μm to 35 μm.

4. The circular saw blade according to claim 1, wherein the coating comprises a Teflon coating, and has a thickness of from 15 μm to 35 μm.

5. The circular saw blade according to claim 1, wherein the circular saw blade is configured to cut aluminum profiles.

6. The circular saw blade according to claim 5, wherein the coating is formed on the tips by using a rotary spray process.

7. The circular saw blade according to claim 6, wherein a spraying solution is applied on the tips by using the rotary spray process, and the spraying solution is prepared by dissolving a dry film lubricant based on molybdenum disulfide, tungsten disulfide or Teflon in a suitable solvent.
